(19) United States
(12) Patent Application Publication
(10) Pub. No.: US 2021/0236384 A1
(43) Pub. Date: Aug. 5, 2021

(54) Lyophilization Bag

(71) Applicants: Matthew P. WATSON, West Point,, PA (US); David. A. HAMILTON, West Point, PA (US); Scott MCFEATERS, West Point, PA (US); Max BLOMBERG, Camarillo, CA (US); Danny ANDRADE, Camarillo, CA (US); Chad CARPENTER, Camarillo, CA (US); Merck Sharp & Dohme Corp., Rahway, NJ (US); Meissner Filtration Products, Camarillo, CA (US)

(72) Inventors: Matthew P. Watson, Ottsville, PA (US); David A. Hamilton, Collegeville, PA (US); Scott McFeaters, Sinking Spring, PA (US); Max Blomberg, Templeton, CA (US); Danny Andrade, Oxnard, CA (US); Chad Carpenter, Somis, CA (US)

(73) Assignee: Meissner Filtration Products, Camarillo, CA (US)

(21) Appl. No.: 17/053,251

(22) PCT Filed: May 2, 2019
(86) PCT No.: PCT/US2019/030318

§ 371 Date: Nov. 5, 2020

Related U.S. Application Data
(60) Provisional application No. 62/667,816, filed on May 7, 2018.

(51) Int. Cl. A61J 1/10; A61J 1/14; F26B 5/06

(52) U.S. Cl. CPC A61J 1/10; F26B 5/06; A61J 1/1481; A61J 1/1418

(57) ABSTRACT

A lyophilization bag is provided herein for containing a solution in a lyophilizer during lyophilization. The lyophilization bag includes a body having a flexible base member, and a flexible top member. The base member and the top member, collectively, at least partially encompass an interior volume of the body. A first portion of the interior volume is defined between at least portions of the base member and a reference plane located spaced from the at least portions of the base member, the first portion of the interior volume defining a volume corresponding to the initial volume of the solution. A second portion of the interior volume is defined between the reference plane and at least portions of the top member. At least one port defining an opening is in communication with the second portion of the interior volume.

### FIELD OF THE INVENTION

The subject invention relates to lyophilization containers for containing a solution in a lyophilizer during lyophilization, more particularly, to lyophilization bags.

### BACKGROUND OF THE INVENTION

Lyophilization is a well-known process in the art used to provide stability to a product for storage which would be otherwise unstable in solution form. During lyophilization, the solution is frozen. Thereafter, a then vacuum is applied and temperature is reduced, to remove the solvent component (typically water) without allowing the frozen product to return to a liquid state. As a result, sublimation occurs which removes the solvent component and causes dehydration of the frozen product. A lyophilized cake is ultimately formed which can be later, in part or wholly, reconstituted as a solution for use.

Different container configurations are known in the art for containing a solution in a lyophilizer during lyophilization. Glass vials have been utilized. However, glass volumes typically contain limited amounts of solution, and are not practical for bulk volume applications. Open trays have been also used. Although trays allow for good surface area exposure, the trays do not provide a resealable cover. Moreover, the trays typically have a robust structure, which acts as an insulator for the solution during lyophilization, resulting in possible slowing down or inhibition of the lyophilization process. The trays also typically requiring molding and, thus, come in a fixed number of shapes and sizes. Further, plastic cups have been utilized. These are typically circular in cross-section, limiting dense packing within a rectangular foot-print typically found in lyophilizers.

### SUMMARY OF THE INVENTION

A lyophilization bag is provided herein for containing a solution in a lyophilizer during lyophilization, the solution being in an initial volume before lyophilization. The lyophilization bag includes a body having a flexible base member, and a flexible top member. The base member and the top member, collectively, at least partially encompass an interior volume of the body. A first portion of the interior volume is defined between at least portions of the base member and a reference plane located spaced from the at least portions of the base member, the first portion of the interior volume defining a volume corresponding to the initial volume of the solution. A second portion of the interior volume is defined between the reference plane and at least portions of the top member. At least one port defining an opening is in communication with the second portion of the interior volume. Advantageously, with the subject invention, a lyophilization bag is provided which may be formed from relatively thin material, allowing for good heat transfer, and easy manufacturing in various shapes and sizes. The port is configured for sealing and re-sealing in allowing for venting during lyophilization, subsequent storage, and access as needed.

Accordingly, the instant invention comprises a lyophilization bag for containing a solution in a lyophilizer during lyophilization, the solution being in an initial volume before lyophilization, the lyophilization bag comprising:

a body having a flexible base member, and a flexible top member, wherein, the base member and the top member, collectively, at least partially encompass an interior volume of the body, wherein, a first portion of the interior volume is defined between at least portions of the base member and a reference plane located spaced from the at least portions of the base member, the first portion of the interior volume defining a volume corresponding to the initial volume of the solution, and, wherein, a second portion of the interior volume is defined between the reference plane and at least portions of the top member; and,

at least one port defining an opening in communication with the second portion of the interior volume.

In an embodiment of the invention, the lyophilization bag further comprises at least one inlet tube having an inner lumen in communication with the interior volume. In a class of the invention, at least one inlet tube is affixed to the front panel.

In an embodiment of the invention, the lyophilization bag further comprises an angled front panel defined by the top member.

In an embodiment of the invention, the lyophilization bag further comprises at least one port which is affixed to the front panel.

In an embodiment of the invention, the base member of the lyophilization bag is sized to rest on a support surface in the lyophilizer in full face-to-face contact. In another embodiment of the invention, the base member has a rectangular configuration. In another embodiment of the invention, the base member is flat.

In an embodiment of the invention, the lyophilization bag further comprises a removable closure for selectively sealing the opening of at least one port.

In an embodiment of the invention, the lyophilization bag further comprises a plurality of hooks or loops spaced across the top member.

In an embodiment of the invention, the lyophilization bag further comprises a flexible side wall member perimetrically bounding, and extending upwardly from, the base member, wherein the top member extends between portions of the side wall member spaced from the base member. In another embodiment of the invention, the side wall member extends continuously between the base member and the reference plane. In another embodiment of the invention, the side wall member extends upwardly from the base member beyond the reference plane.

In an embodiment of the invention, the reference plane is generally parallel to the base member of the lyophilization bag.

In an embodiment of the invention, the base member of the lyophilization bag is directly joined to the top member to define a sealed joint therebetween. In another embodiment of the invention, the sealed joint is formed by one or more of heat sealing, fusion, and an adhesive. In another embodiment of the invention, the sealed joint perimetrically bounds the interior volume.

These and other features of the subject invention will be better understood through a study of the following detailed description and accompanying drawings.

The lyophilization bag of the invention can be used in connection with a wide variety of lyophilizers, as can be appreciated by one skilled in the art. Typical lyophilizers can be grouped by size & use: (1) laboratory bench-top units for research and development, (2) pilot units for process development and scale-up, and (3) larger production-sized units. It should be noted that in addition to process scale-up work, pilot-sized lyophilizers are often used for product research and development as well as small volume production applications. Choosing a lyophilizer depends on the product characteristics as well as many other application-based variables including the container that the product will be dried in, the shelf area or number of ports required to accommodate the quantity to be dried in each batch, the total volume of ice to be condensed and whether there are any organic solvents. The type and shape of product being dried and its end-use also need to be considered.

### BRIEF DESCRIPTION OF THE DRAWINGS

FIG. 1. shows a 3D view of a lyophilization bag having a base member, side wall member and a top member.

FIG. 1A. shows a 3D view of a lyophilization bag formed by fusing the base member and the top member together.

FIG. 2. Shows a 2D, side view of a lyophilization bag with the port being open so that vapor may be vented from a contained solution through the opening during lyophilization.

FIG. 3. shows a 3D view of a lyophilization bag having a base member, side wall member and a top member with a removable closure.

FIG. 4. shows a 3D view of a lyophilization bag having a base member, side wall member, front panel and a top member.

FIG. 5. shows a 3D view of a lyophilization bag having a base member, side wall member, front panel and a top member with a removable closure.

FIG. 6. shows a 3D view of a lyophilization bag having a base member, side wall member, front panel and a top member, with ventilation and tubing ports.

FIG. 7. shows a 3D view of a lyophilization bag having a base member, side wall member, front panel and a top member, with two inlet tubes and a removable closure.

FIG. 8. shows a 3D view of a lyophilization bag having a base member, side wall member, front panel and a top member with hangers.

FIG. 9. shows a 3D view of a lyophilization bag having a base member, side wall member, front panel and a top member, with two inlet tubes, multiple ventilation ports with removable closers, and multiple hangers.

FIG. 10. shows a top view of a lyophilization bag having a base member, side wall member, front panel and a top member, with two inlet ports and four ventilation ports. There are multiple hangers pictured that are capable of engaging external supports to prevent sagging.

FIG. 11. shows a photograph of a rod threaded through a hanger.

FIG. 12. shows a photograph of a of a lyophilization bag having a base member, side wall member, front panel and a top member, with two inlet tubes and multiple ports. There are multiple hangers threaded with rods.

FIG. 13. shows a cross section of a multilayered, flexible material that can be used to fashion the base member, side wall member, top member and/or front panel.

### DETAILED DESCRIPTION OF THE INVENTION

A lyophilization bag is provided herein, shown in various embodiments in the Figures and generally designated with reference numeral 10. In a first embodiment, the bag 10 includes a body 12, having a flexible, generally flat base member 14, a flexible side wall member 16 perimetrically bounding, and extending upwardly from, the base member 14, and a flexible top member 18 extending between portions of the side wall member 16. The base member 14, the side wall member 16, and the top member 18 at least partially encompass an interior volume 20 of the body 12. The top member 18 may be parallel to the base member 14. The base member 14, the side wall member 16, and the top member 18 may be cut pieces of flexible material which are joined (e.g., by fusion and/or adhesion) to form the bag 10.

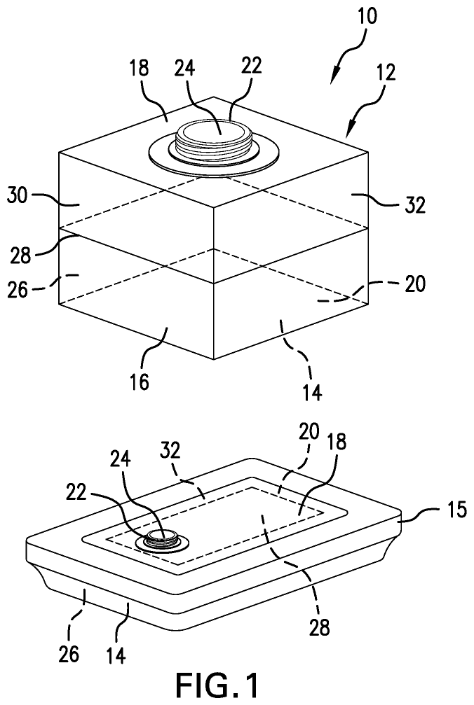

With reference to FIG. 1A, in a second embodiment, the bag 10 may be formed by directly joining portions of the base member 14 to portions of the top member 18, without inclusion of the side wall member 16, to define a sealed joint 15. The sealed joint 15 may be formed by one or more of heat sealing, fusion, and an adhesive. Preferably, the sealed joint 15 is at least liquid tight, and, possibly fluid tight. The sealed joint 15 may perimetrically bound the interior volume 20.

The bag 10 further includes at least one port 22 defining an opening 24 in communication with the interior volume 20, as described below. The port 22 is referenced herein in the singular for illustrative purposes, such references not intending to preclude the use of a plurality of the ports 22.

The bag 10 may have a generally rectangular shape. It is preferred that the bag 10 have an overall plate-like configuration with the base member 14 being more expansive than the height of the body 12, as defined by a maximum height of the interior volume 20. It is preferred that the base member 14 be rectangular. This allows for better accommodation in a lyophilizer which typically includes rectangular-shaped support surfaces, such as shelves, for supporting lyophilization containers.

The base member 14, the side wall member 16, and the top member 18 are formed of flexible material, such as thermoplastic film, which imparts overall flexibility to the bag 10. With the bag 10 being formed of flexible material, the bag 10 may be readily prepared in various sizes and configurations. The bag 10 is preferably configured to accommodate a target amount of solution intended for lyophilization. As shown in FIGS. 1 and 1A, a first portion 26 of the interior volume 20 is defined between portions of the base member 14 and a reference plane 28 located spaced from portions of the base member 14. The reference plane 28 may be parallel to the base member 14. The first portion 26 of the interior volume 20 defines a volume corresponding to the initial volume of the solution intended for lyophilization. A second portion 32 of the interior volume 20 is defined between the reference plane 28 and at least portions of the top member 18. The second portion 32 of the interior volume 20 is contiguous with the first portion 26 of the interior volume 20 with open communication therebetween. The side wall member 16, if utilized, may extend continuously between the base member 14 and the reference plane 28 about the base member 14. Portions 30 of the side wall member 16 may extend upwardly beyond the reference plane 28 in a direction away from the base member 14.

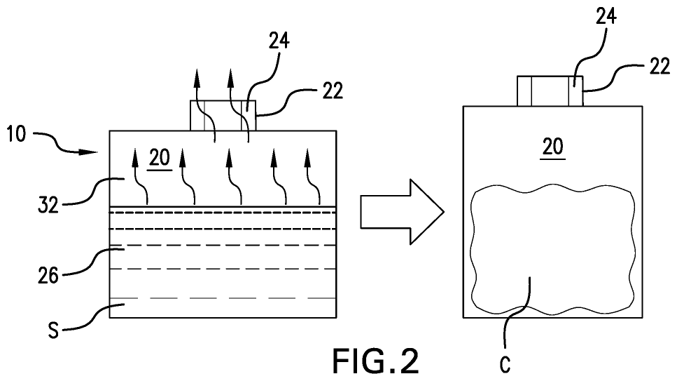

The port 22 is fixed to the body 12 to have the opening 24 be in communication with the second portion of the interior volume 20. As shown in FIG. 2, with this arrangement, and with the port 22 being open (i.e., not sealed), vapor may be vented from contained solution S through the opening 24 during lyophilization. This allows for desired dehydration in the lyophilization process. As a result of the lyophilization process, the solution S is sufficiently dehydrated to form a cake C.

The bag 10 may be provided with gussets or pockets of extra material to facilitate expansion during use, particularly with the solution S being contained therein.

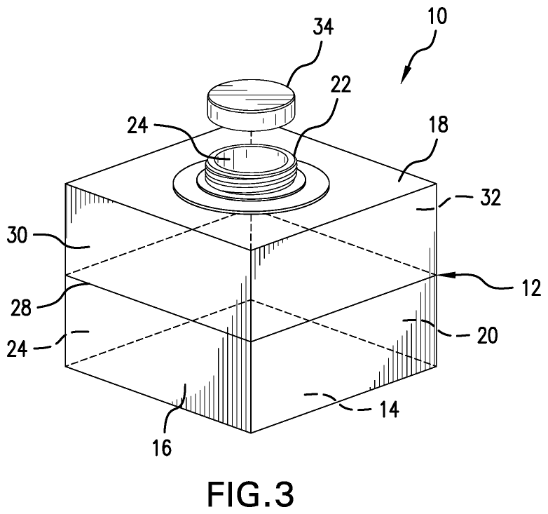

As shown in FIG. 3, a removable closure 34 may be provided for selectively sealing the opening 24 of the port 22. The closure 34 is preferably non-vented, but may be vented if necessary. The closure 34 and the port 22 may be configured and/or provided with any dimensioning and/or features which allows for the mounting and removal of the closure 34 to, and from, the port 22, including, but not limited to, cooperating threads, bayonet-lock arrangement, friction fit, interference fit, and so forth.

The port 22 may be used as a passage for the solution S into the bag 10 in preparation for lyophilization and later used to remove lyophilized (e.g., in the form of the cake C), or reconstituted matter. With the subject invention, the solution S may be disposed into the bag 10 externally of the lyophilizer with the closure 34 being secured to the port 22 to provide a seal during transportation. When ready, the bag 10 may be placed onto a support surface in a lyophilizer, with subsequent removal of the closure 34.

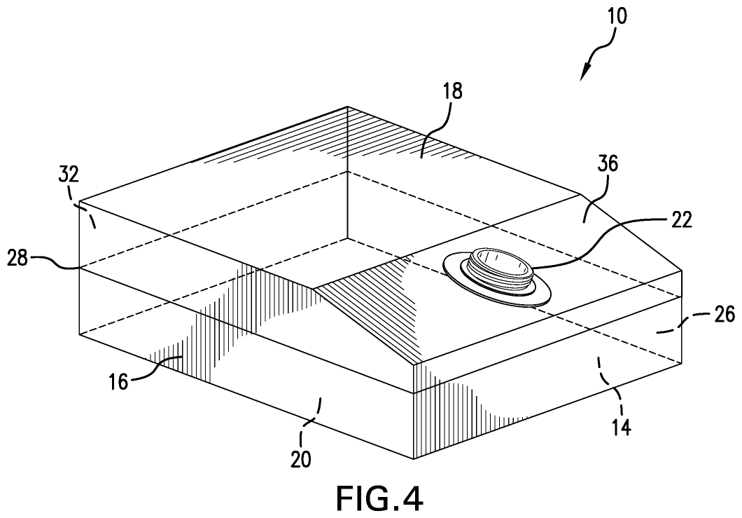

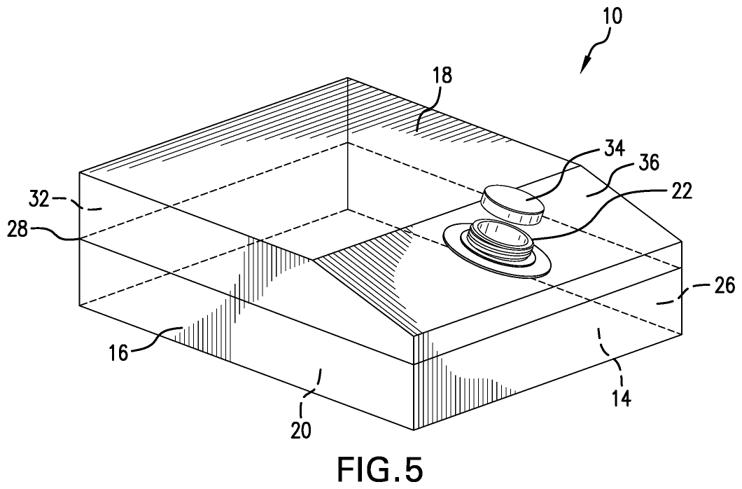

As shown in FIGS. 4 and 5, a front panel 36 may be defined by portions of the top member 18. The port 22 may be affixed to the front panel 36. Preferably, the front panel 36 is angled to provide better viewing for a user of any features mounted to the front panel 36.

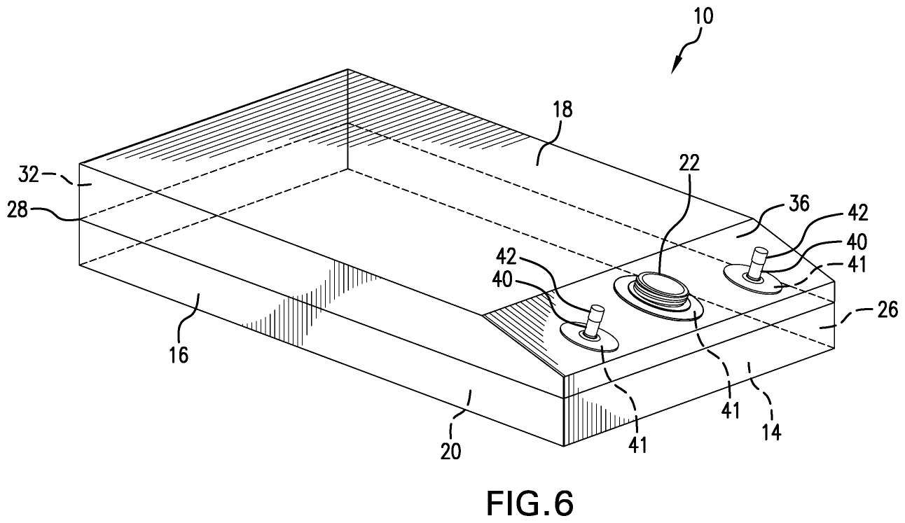

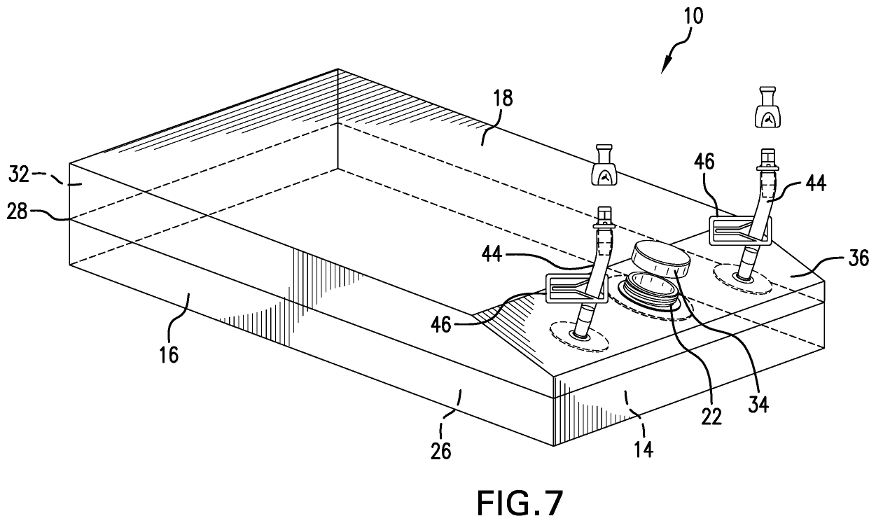

As additional features, as shown in FIGS. 6 and 7, one or more inlet tubes 38 may be provided each having an inner lumen 40 in communication with the interior volume 20. The inlet tubes 38 may be used to introduce the solution S in preparing the bag 10 for lyophilization. In this manner, the port 22 may remained sealed with the closure 34 during preparation of the bag 10, thereby, maintaining sterility of inner portions of the bag 10, including within the port 22. Once readied and placed in the lyophilizer, the closure 34 may be removed to allow for venting of the vapors with sterility being maintained.

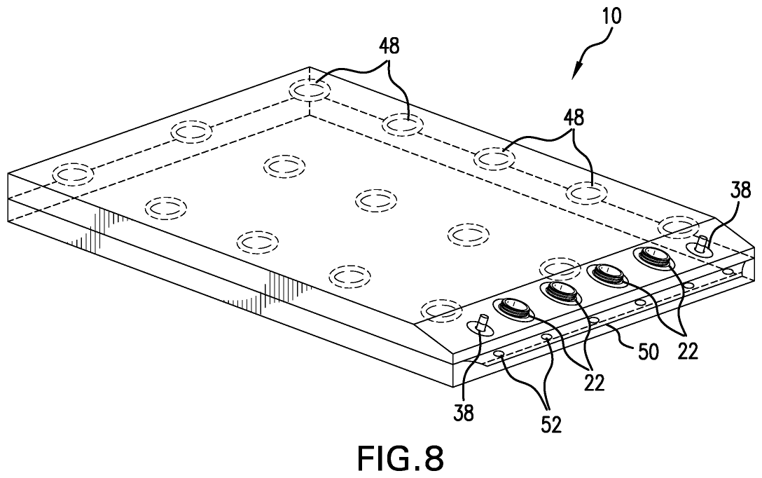

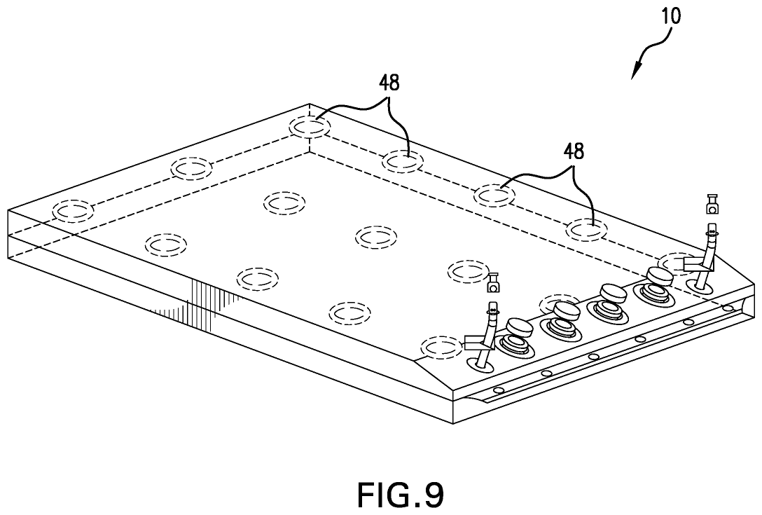

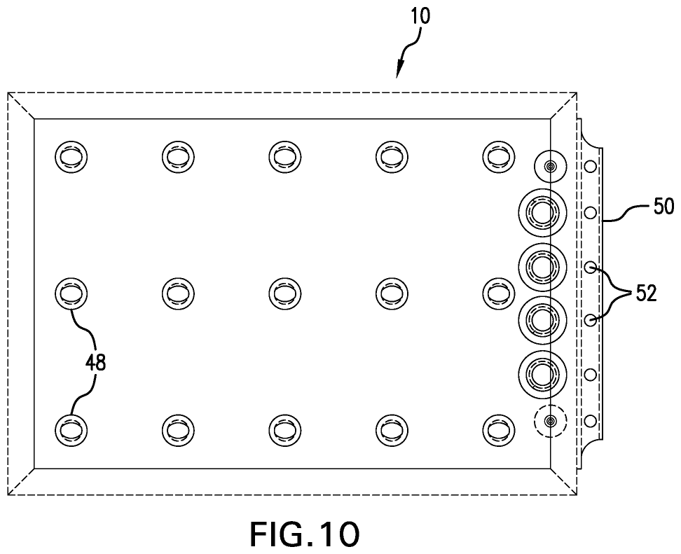

As shown in FIGS. 8-10, the inlet tubes 38 may be affixed to the body 12 in any known manner. The inlet tubes 38 may be affixed to the front panel 36, if utilized. It is preferred that the inlet tubes 38 be provided with limited length to facilitate handling. The inlet tubes 38 may be rigid and be provided with barbs 42 for attaching to auxiliary tubing 44 which may be provided to allow for greater reach and flexibility for handling the solution S. One or more tubing clamps 46 may be provided for selectively sealing the auxiliary tubing 44.

Mounting collars 41 (FIG. 6) may be affixed to any of the ports 22 and/or the inlet tubes 38 to be secured over an adjacent area of the body 12. The mounting collars 41 allow for face-to-face connection with a portion of the body 12 (e.g., the front panel 36) about the respective port 22/inlet tube 38 to provide a higher-level of connection and sealing.

The inlet tubes 38 may be used in any combination in introducing the solution S into the bag 10. For example, the inlet tubes 38 may be used in parallel to introduce the solution S. One or more of the inlet tubes 38 may act as a vent during loading of the solution S, particularly with the port 22 being closed.

As shown in FIGS. 8-10, a plurality of the ports 22 may be provided for the bag 10. This allows for better venting with the bag 10 containing a relatively greater volume of the solution S. To allow for proper venting, it is preferred that a sufficient amount of port area be provided relative to the liquid surface area of the body 12. The liquid surface area is the area of internal surfaces of the body 12 in contact with the interior volume 20 (i.e., the internal surfaces which are located on the base member 14, the side wall member 16 (if utilized), and the top member 18 in contact with the interior volume 20). In particular, it is preferred that the liquid surface area of the body 12 be provided in a ratio of 70:1 to 125:1 relative to the collective area of all of the openings 24 of the ports 22, more preferably, in a range of 110:1 to 125:1. The quantity of the ports 22 may vary. For example, the ratio may be satisfied with the use of one larger opening 24 or by a plurality of smaller openings 24.

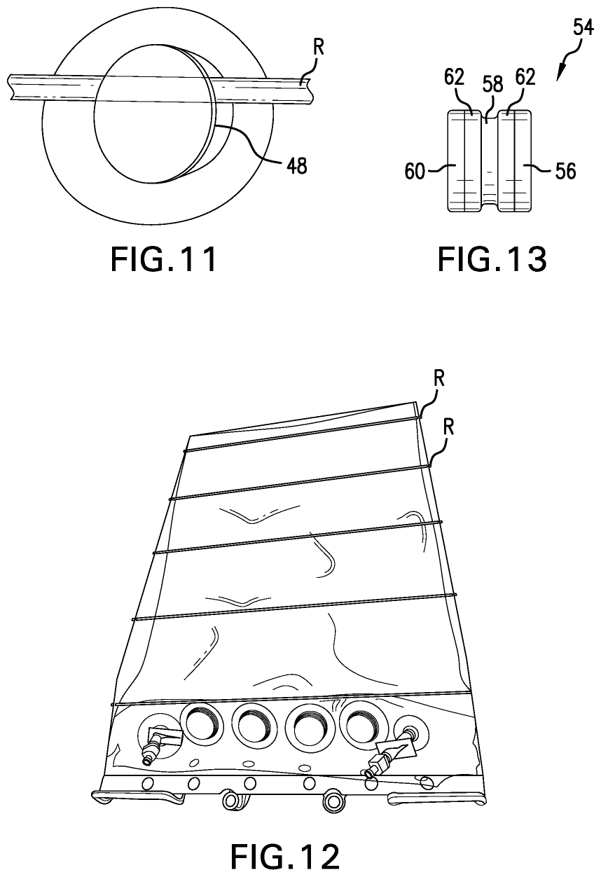

A plurality of hangers 48 may be provided on the top member 18 configured to engage external supports to minimize sagging in the top member 18. With the top member 18 being flexible, the top member 18 may sag into the second portion 32 of the interior volume 20 and restrict the flow of vapors. The hangers 48 may be provided in various configurations. As shown in FIGS. 8-10, the hangers 48 may be disks having slits therein formed to deflect and allow for engagement with a hook or other support. The hangers 48 may be also formed to be hook or loop shaped. The hangers 48 may be arranged in a matrix, for example with a series of the hangers 48 being aligned to have the slits positioned to be engaged by a common support member, such as a rod R. In this manner, the rod R may be threaded through a series of the hangers 48, as shown in FIGS. 11-12. The top member 18 may be supported by a plurality of the rods R (which may be arranged in parallel). The rods R may be supported by a rack or other support structure.

A flange 50 may be provided with the bag 10. The flange 50 may be formed by portions of the body 12 or as a feature extending from portions of the body 12. For example, with reference to the embodiment of FIG. 1, the flange 50 may extend from the side wall member 16. Also, for example, with reference to the embodiment of FIG. 1A, the sealed joint 15 may define the flange 52. The flange 52 may include one or more apertures, engageable to provide a holding or tensioning force to the bag 10 during use.

The bag 10 may be used to transport and store the lyophilized cake C. A portion of the cake C may be removed through one or more of the ports 22 in lyophilized form. The entire lyophilized cake C may be reconstituted inside the bag 10 with diluent being added through the port(s) 22 and/or the inlet tube(s) 38. With the diluent being introduced into the interior volume 20, the bag 10 may be sealed (e.g., with the closure(s) 34 and the tubing clamps 46) and caused to be rocked or otherwise agitated to facilitate reconstitution of the entire cake.

The flexible material of the base member 14, the side wall member 16, if utilized, and the top member 18 is preferably impervious to gas transmission. In this manner, venting is restricted through the ports 22 with no infiltration of air through the walls of the bag 10. As shown in FIG. 13, the flexible material is preferably a multi-layered structure 54 with a first liquid contact surface 56 for being in contact with the interior volume 20. The first liquid contact layer 56 must be compatible (i.e., be generally non-reactive) with the solution S and the cake C.

The lyophilization bag of the invention may be made from materials commonly used to manufacture lyophilization containers and known to those skilled in the art. For example, the first liquid layer 56 may include polyethylene (in various densities, cross-linked, and as a copolymer). A second gas barrier layer 58 is provided with the multi-layered structure 54 internally of the first liquid contact layer 56. The second gas barrier layer 58 may include ethylene vinyl alcohol (EVOH) or other materials known to those skilled in the art as resistant to gas transmission and suitable for use in the manufacture of lyophilization bags. The multi-layered structure 54 may include a third outer layer 60 and tie layers 62 as needed. The third outer layer 60 may include polyethylene or polyester, or other materials known to those skilled in the art. In an embodiment of the invention, the lyophilization bag is made from low density polyethylene.

What is claimed is:

1. A lyophilization bag for containing a solution in a lyophilizer during lyophilization, the solution being in an initial volume before lyophilization, the lyophilization bag comprising:
a body having a flexible base member, and a flexible top member, wherein, the base member and the top member, collectively, at least partially encompass an interior volume of the body, wherein, a first portion of the interior volume is defined between at least portions of the base member and a reference plane located spaced from the at least portions of the base member, the first portion of the interior volume defining a volume corresponding to the initial volume of the solution, and, wherein, a second portion of the interior volume is defined between the reference plane and at least portions of the top member; and,
at least one port defining an opening in communication with the second portion of the interior volume.

2. The lyophilization bag as in claim 1, further comprising at least one inlet tube having an inner lumen in communication with the interior volume.

3. The lyophilization bag as in claim 1, further comprising an angled front panel defined by the top member.

4. The lyophilization bag as in claim 3, wherein at least one port is affixed to the front panel.

5. The lyophilization bag as in claim 3, further comprising at least one inlet tube having an inner lumen in communication with the interior volume, wherein at least one inlet tube is affixed to the front panel.

6. The lyophilization bag as in claim 1, wherein the base member is sized to rest on a support surface in the lyophilizer in full face-to-face contact.

7. The lyophilization bag as in claim 1, further comprising a removable closure for selectively sealing the opening of at least one port.

8. The lyophilization bag as in claim 1, wherein the base member has a rectangular configuration.

9. The lyophilization bag as in claim 1, further comprising a plurality of hooks or loops spaced across the top member.

10. The lyophilization bag as in claim 1, further comprising a flexible side wall member perimetrically bounding, and extending upwardly from, the base member, wherein the top member extends between portions of the side wall member spaced from the base member.

11. The lyophilization bag as in claim 10, wherein the side wall member extends continuously between the base member and the reference plane.

12. The lyophilization bag as in claim 10, wherein the side wall member extends upwardly from the base member beyond the reference plane.

13. The lyophilization bag as in claim 1, wherein the base member is flat.

14. The lyophilization bag as in claim 13, wherein the reference plane is parallel to the base member.

15. The lyophilization bag as in claim 1, wherein the base member is directly joined to the top member to define a sealed joint there between.

16. The lyophilization bag as in claim 15, wherein the sealed joint is formed by one or more of heat sealing, fusion, and an adhesive.

17. The lyophilization bag as in claim 15, wherein the sealed joint perimetrically bounds the interior volume.
